(19) United States
(12) Patent Application Publication
(10) Pub. No.: US 2011/0184799 A1
(43) Pub. Date: Jul. 28, 2011

(54) Marketing Methods for Goods and Services

(76) Inventors: Lynn Anne Henderson, Marion, IL (US); Archie Bob Henderson, Marion, IL (US)

(21) Appl. No.: 13/076,506

(22) Filed: Mar. 31, 2011

Related U.S. Application Data
(63) Continuation-in-part of application No. PCT/US2009/061400, filed on Oct. 21, 2009.
(60) Provisional application No. 61/109,527, filed on Oct. 30, 2008.

(51) Int. Cl. G06Q 30/00

(52) U.S. Cl. 705/14.39; 705/14.4

(57) ABSTRACT

A marketing method for goods or services includes assigning at least one telephone number and a web page to at least one user for offering goods and/or services for sale to at least one prospective buyer; contacting the telephone number; and sending a message to the at least one prospective buyer's mobile phone, personal digital assistant, or smart phone, the message providing a web address for the web page for obtaining information about the goods and/or services.

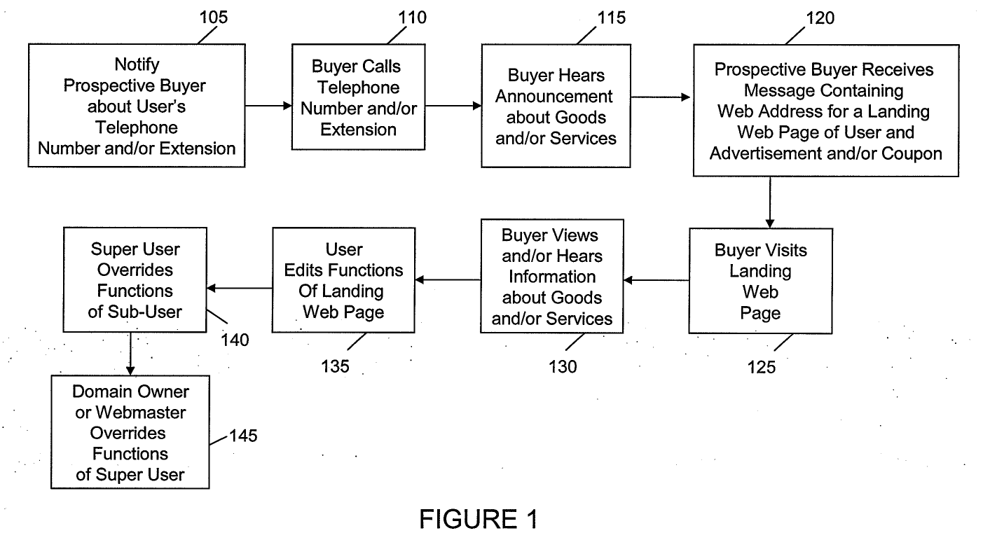

This application is a Continuation-In-Part application of PCT international patent application PCT/US2009/061400 filed on 21 Oct. 2009 and claims priority to U.S. provisional patent application No. 61/109,527 filed in the U.S. Patent and Trademark Office on 30 Oct. 2008, the entireties of which are incorporated herein by reference.

### TECHNICAL FIELD

The present invention is directed to methods for marketing the sale of goods and/or services and for disseminating information about such goods and/or services to prospective buyers.

### BACKGROUND OF THE INVENTION

Most people who are shopping for a product or service are often reluctant to talk to a seller. For example, prospective buyers of a new home may want to get detailed information about the features of the home, such as its price, bedrooms, square footage, lot size, and the like; however, they are often reluctant to contact the realtor who has listed the home for sale because they are not ready to talk to a realtor. In fact, studies have shown that potential buyers prefer to obtain as much information as possible before having any human contact.

### SUMMARY OF INVENTION

It is an object of the present invention to allow potential buyers to obtain information about goods and/or services without requiring them to talk to anyone.

It is an object of the present invention that allows prospective buyers to utilize at least one of a mobile telephone, personal digital assistant, or smart phone, and the internet to obtain information about goods and/or services.

It is another object of the invention to allow users (sellers) to easily update information on a web page about the goods and/or services for sale.

It is a further object of the invention to allow a seller/user having a plurality of geographical locations to standardize, control, and populate information provided by each local user to prospective buyers at each geographical location.

According to an aspect of the present invention, a method for marketing goods and/or services includes assigning at least one telephone number and a web page to at least one user for offering goods and/or services for sale to at least one prospective buyer; contacting the telephone number; and sending a message to the at least one prospective buyer's mobile telephone, personal digital assistant, or smart phone, the message providing a web address for the web page for obtaining information about the goods and/or services. The web page and/or message may offer at least one of coupons, discounts, or promotions.

In the following description, reference is made to the accompanying drawing, which is shown by way of illustration to specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### BRIEF DESCRIPTION OF THE DRAWING

The sole FIGURE is a schematic flowchart of a method according to an exemplary embodiment of the present invention.

### DETAILED DESCRIPTION OF INVENTION

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated. Thus, the invention can include any variety of combinations and/or integrations of the embodiments described herein.

A marketing method according to the present invention provides Users (sellers) the ability to facilitate the sale of goods and/or services and to disseminate information to prospective buyers. In specific embodiments, Users of the marketing methods may be charged a fee (e.g., a weekly, monthly, or yearly fee). For example, a User may be charged different subscription fees by at least one of an internet domain owner or webmaster based on a level of user access to the different features discussed below.

Goods and/or services that may be marketed according to the present invention may include, but are not limited to, real estate (e.g., homes, apartments, condos, vacant land, subdivision lots, office buildings, commercial properties, warehouse space, industrial buildings, rentals); vehicles (e.g., cars, trucks, motorcycles, boats, RVs); medical services (e.g., hospital services, physician services, dental services); legal services, club functions, church functions, school functions, restaurant and bar services, construction equipment, government (e.g., city, state, federal) goods and services; chambers of commerce; civic organizations; non-profit service organizations; shelters; or other goods and/or services.

Telephone Number

According to the present invention, at least one unique telephone number (e.g., toll-free number) may be assigned to each User (seller). For the at least one telephone number, there is a corresponding world wide web page (a landing web page) where the User can display information about the goods and/or services the User is offering for sale. In the discussion below, an embodiment directed to a toll-free telephone number is discussed; however, the invention may include other kinds of telephone numbers or telephone access.

In specific embodiments, a User may require a single toll-free telephone number with at least one extension, and one landing web page (in addition to an administrative web page discussed below) because the goods and/or services can be adequately described with a single web page.

However, in other embodiments, Users who have many different goods and/or services to sell (for example, car dealers, real estate agencies, or large merchants) may need a toll-free number with a plurality of extensions, with each extension having a corresponding landing web page. For example, owners or managers of apartment complexes may utilize different extensions for each apartment unit, or for groups of apartment units that are similar in price and features. Inquiring buyers or renters may be directed to specific extensions where they can be informed of features, availability, monthly rent, security deposit required, and the like for each unit.

According to the present invention, a prospective buyer of goods and/or services is notified of at least one of a telephone number or a landing web page providing information about the goods and/or services. In specific embodiments, a prospective buyer may be notified by an e-mail, a text message, a flyer, a newspaper or magazine advertisement, a television or radio commercial, a sign, a business card, a web advertisement, a hyperlink, or the like.

In specific embodiments, the prospective buyer calls a toll-free telephone number and/or the extension corresponding to the good or service of interest. The prospective buyer may utilize a mobile phone, personal digital assistant, or smart phone (a cell phone having web browser and/or video capabilities). During the telephone call, the prospective buyer hears a recorded announcement comprising a greeting and information about the goods and/or services offered for sale by a User. The recorded announcement may also include an advertisement. For example, a prospective buyer of a vehicle may call a toll-free telephone number. A main greeting may advise the potential buyer to dial the extension of the vehicle he is interested in. When the prospective buyer dials that extension, a recorded announcement or audio file describes features of that particular vehicle and at least one of special deals, financing offers, ads from banks or insurance agencies, or the like that will play automatically. At the end of the recorded announcement, a prospective buyer may have the option to leave a message or to be automatically connected to the User at a telephone number pre-designated by the User. In specific embodiments, the User may designate up to three telephone numbers via which a prospective buyer may be automatically connected.

In specific embodiments, the recorded announcement also indicates that additional information may be obtained by accessing a web site or web page. In other embodiments, instead of calling a telephone number and hearing a recorded announcement, a prospective buyer may text a telephone number and receive information about the goods and/or services and a web address by a return message as discussed below.

After calling or texting a telephone number, a prospective buyer is sent at least one of an e-mail, text message, or multimedia message, each comprising a web address for the landing web page corresponding to the telephone number. The e-mail, text message, or multimedia message mail comprises information about the goods and/or services including, but not limited to, text, pictures, sounds, video, mp3 files, or location data (e.g., at least one of an address, directions, or map). In specific embodiments, the at least one of an e-mail, text message, or multimedia message may comprise at least one of an advertisement or a coupon.

In specific embodiments, a prospective buyer's telephone number and name may be recorded, if known. The length of time that each caller accessed the toll-free telephone number or extension and whether or not the caller left a voice message may also be captured. As each call is received, a forwarding message (e.g., e-mail, text, or multimedia message) may be sent to a User or designated individual, advising that a call was received, a time the call was received, and displaying the prospective buyer's number and name (if known). These notification settings may be adjusted by a User. Similarly, a User may adjust settings to provide a sequential list of individuals to whom the forwarding message should be sent (“follow-me rules”). If the prospective buyer leaves a voice message, a forwarding message including the voice message, for example, as a way or mp3 file, may be automatically sent to the User.

Landing Web Page(s)

On a landing web page corresponding to the at least one telephone number (e.g., toll-free telephone number) or extension, a User may display information about the goods and/or services offered for sale so a prospective buyer can readily obtain such information via access to the world wide web via a web browser.

In specific embodiments, a User may upload at least one of text, contact information, links to other web sites, photos, slideshows, flash presentations, or sound files to the landing web page regarding the goods and/or services described in the corresponding telephone number or extension. The User may edit, modify, or delete information by accessing an Administrative page as discussed below. In an exemplary embodiment, a User selling real estate may upload pictures and/or video of an exterior and interior of a property, edit a recorded announcement, and post contact information for a listing realtor, owner, or manager.

The landing web page may comprise at least one of a button or link that can be pressed which will play the recorded announcement again or a button or link that can be clicked to automatically call or e-mail the User. In specific embodiments, a User may upload text that may be automatically converted to a sound file (e.g., mp3 file) and used to populate a main greeting of the corresponding telephone number and/or extension, which will play when a prospective buyer dials that telephone number and/or extension.

The landing web page may also have advertisements. Such advertisements may include, but are not limited to, advertisements for banks, insurance agencies, decorating services, legal services, medical services, or the like. In specific embodiments, advertisements on a landing web page may be controlled by at least one of a domain owner or webmaster.

The landing page may also include at least one coupon that can be printed or emailed. In a specific embodiment, the at least one coupon may include at least one of a summary description of the good and/or, a regular price, a discount applicable because of the coupon, a final price, an expiration date for the coupon, or an image of at least one of the good or service. The User's contact information may automatically be entered on the at least one coupon upon creation of the at least one coupon.

In a specific embodiment, when a customer or prospective buyer visits a landing page, his or her IP address may be automatically checked to determine geographic location and the landing page will load coupons applicable to merchants in that city, state, or region.

According to a specific embodiment, a main web page may be provided for a plurality of Users, with unique landing web pages for each User branching off or linking to the main web page. A main web page for a plurality of Users may be dedicated to the particular product or service. For example, in specific embodiments, a web address for a main web page may be www.cellthisdealer.com; www.cellthisvehicle.com; www.cellthishome.com; www.cellthisstore.com; www.cellthiscity.com; www.cellthisdoctor.com; www.cellthisequipment.com; www.cellthisrv.com; www.cellthisboat.com; www.cellthisharley.com; www.cellthisbuilder.com; or www.cellamenu.com.

In specific embodiments, a web address for a landing web page may be associated with the toll-free telephone number assigned to a particular User. For example, several Users may seek to sell vehicles. A main web page for all such Users may be, for example, www.cellthisdealer.com. However, an individual User assigned a distinct toll-free telephone number 800.555.2222 may have a corresponding unique landing web page with the address cellthisdealer.com/8005552222. Alternatively or in addition, a User may provide an identifier (ID) for the landing web page. For example, a User seeking to sell a vehicle at a specific dealership (e.g., Marion Ford®), may choose an ID: marionford. Thus, a prospective buyer may access the landing web page via, for example, cellthisdealer.com/8005552222 and/or www.cellthisdealer.com/marionford.

In specific embodiments for Users having a toll-free telephone number with a plurality of extensions, there may be a personal main web page, as well as a unique landing web page for each extension. In specific embodiments, each extension purchased by a User will automatically enable a landing web page whose address corresponds to the extension. For example, for a toll-free telephone number 800.555.2222, extension 101, a corresponding landing web page upon which the User can display information about that specific good and/or service for sale will correspond to the extension (e.g., cellthisdealer.com/8005552222/101).

Administrative Web Page

Each User may have an administrative web page (e.g., a “My account” page). After entering a password and accessing the administrative web page, a User may be able to do one or more of the following:

set up or edit a main greeting for a telephone number or extension;

set up or edit existing extensions and related landing web pages in order to add, edit or delete information for goods and/or services;

set up or edit announcements for each extension;

set up or edit voicemail settings for a telephone number or extension;

set up or edit notification settings, to notify a User or other individual when a prospective buyer calls a telephone number or extension or visits a landing web page;

create or set up a viewable, printable coupon that can be sent via text or email;

set up or edit follow me rules, to alert a User or sequential list of individuals when a prospective buyer calls a telephone number or extension and presses a button, link, or key to be automatically connected to the User or sequential list of individuals or to alert the User or list of individuals when the buyer visits a landing web page;

block telephone numbers;

edit a User profile;

view currently displayed products and/or services;

view or edit a User page (a page displaying the User's contact information); or

view or edit and enable or disable a function whereby a message is automatically sent to each buyer who calls or texts the telephone number and/or extension.

From the Administrative web page, a User may be able to view and download (e.g., *.csv or pdf format) a report of activity for at least one of a telephone number and/or extension; activity for a main web page; or activity for an individual landing web page. The activity report may be for a user-selected specific time period. For at least one of a toll-free telephone number or extension, the activity report may show at least one of how many calls were received in total, how many calls were received for each extension, the length of each call, or whether or not a message was left. For a landing web page, the activity report may show at least one of the number of times the User's landing site was visited, how many times each page was visited, the length of each visit, or the number of click-throughs to the User's own website.

In a specific embodiment, a User sets up at least one coupon. A template may open where the User can enter at least one of a summary description of a good and/or service, a regular price, a discount percentage applicable to the good and/or service because of the coupon, a final price, an expiration date for the coupon, or any image. The User's contact information may automatically be entered on the at least one coupon.

A User can review the at least one coupon and, when satisfied with it, publish it. Clicking Publish automatically uploads the at least one coupon to a landing page and/or to a separate web page where a plurality of coupons are displayed and found via a search feature. When customers or consumers visit a webpage, their IP address will automatically determine their geographic location and coupons will load that are applicable to merchants in that city, state, or region. Thus, in a specific embodiment, for a subscription fee, small and large businesses are able to automatically create, instantly upload, and simultaneously offer different coupons while also benefiting from numerous other lead generation, lead tracking and mobile marketing features.

In a specific embodiment, a User may also have the ability, for example by clicking “Publish”, to upload at least one coupon to at least one of a social-networking or a special offer/coupon website, such as FACEBOOK®, TWITTER®, LINKEDIN®, GROUPON®, LIVINGSOCIAL®, or a coupon aggregator site, thus enhancing the visibility and distribution of the at least one coupon and improving a merchant's chances of having their webpages found by web crawler “spiders” such as those used by GOOGLE®, YAHOO® and BING®.

The administrative web page is advantageous because participating Users may make frequent additions and deletions to their web pages as inventory changes without requiring assistance from a domain owner, webmaster, or anyone else:

Super User Functionality

A Super User is a User that has multiple locations (e.g., Pizza Hut®, KFC®, Hilton Hotels®, Columbia HealthCare®), with individual Users (local User or sub-User) at each location. Significantly, the present invention provides for Super User functionality for a toll-free telephone number with multiple extensions, in which each extension may be assigned to a different geographic location, for example, a sub-User comprising a local franchise, subsidiary, or related company of the Super User.

From a Super User Administrative web page, a Super User may have the ability to administer certain aspects of each local User or sub-User's account (thereby overriding the local User or sub-User's access to those functions) in order to standardize, control, and populate at least one of:

a main greeting heard by a prospective buyer who calls a toll-free telephone number;

an announcement heard by a prospective buyer who enters any extension of the toll-free telephone number;

a web page announcement (e.g., audio or video) heard or seen by a prospective buyer who visits a local User or sub-User landing web page;

web page graphics, for example, a flash presentation and text seen by a prospective buyer who visits a local User or sub-User landing web page;

automatic SMS text, email, graphics, and video messages sent to a prospective buyer who calls a toll-free telephone number or extension; or

advertisements and/or marketing messages for a telephone number or landing web page.

According to the present invention, a Super User has the ability to selectively apply any or all of the above functions to: individual extensions; groups of extensions; or all extensions. A Super User may also adjust different functions in different geographical areas. If activated by a Super User, all the above functions may be grayed out and denied to individual local Users or sub-Users. If deactivated, the above functions would no longer be grayed out and control may revert to individual local Users or sub-Users.

Domain Administrative Web Page

For each web domain (e.g., cellthisvehicle.com), there may be a password-protected Administrative web page at which a domain owner and/or a designated webmaster can perform at least one of the following functions (thereby overriding a User, Super User, local User, or sub-User's access to those functions):

change a landing web page;

change, upload, and download advertisements and/or coupons on each User's web page;

assign toll-free telephone numbers, extensions, and related landing web pages to participating Users and designate alternate methods of identifying Users;

assign additional extensions/web pages to existing Users based on a paid level of participation or subscription fees;

disable extensions/web pages of Users whose accounts with the domain owner are delinquent;

view and download activity reports of phone service usage (incoming and outgoing);

view and download activity reports of message usage;

view and download activity reports of visits to each User's web page and click-throughs to a User's own (primary) website;

view and download activity reports of click-throughs to advertiser sites;

view, edit, or modify billing charges or fees for each User and generate invoices for each User; or

view, edit, or modify billing charges or fees for each advertiser and generate invoices for each advertiser.

In specific embodiments, an individual User may not be able to change or delete the advertisements on a landing web page. The present invention provides additional revenue sources beyond the subscription fees of Users because of advertising revenue that can be generated from advertisements prospective buyers hear when they call the telephone number, advertisements that prospective buyers see and/or hear via a message on their mobile phone, PDA, or smart phone, and advertisements that can be displayed on the landing web page.

The sole Figure shows a non-limiting, exemplary method according to an embodiment of the present invention. A prospective buyer is notified of a User's telephone number and/or at least one extension 105. The prospective buyer calls the telephone number and/or at least one extension 110. The prospective buyer hears an announcement about the goods and/or services the User is offering for sale 115. The prospective buyer receives a message comprising a web address for a landing web page for obtaining additional information about the goods and/or services and optionally an advertisement and/or coupon 120. The prospective buyer visits the landing web page 125 and views and/or hears information about the goods and/or services 130. The User (e.g., sub-User) edits functions of the landing web page via an administrative web page 135. A Super User overrides the sub-User and edits functions of the sub-User's web page 140. A domain owner and/or webmaster overrides and edit functions of the Super User 145.

Computer program elements of the invention may be embodied in hardware and software. The invention may take the form of a computer program product, which can be embodied by a computer-readable storage medium having computer-usable or computer-readable program instructions, “code” or a “computer program” embodied in the medium for use by or in connection with an instruction execution system. A computer-readable storage medium may be any medium that can contain, store, and communicate the program for use by or in connection with the instruction execution system, apparatus, or device. The computer-usable or computer-readable storage medium may be, for example but not limited to, an electronic, magnetic, optical, electromagnetic, infrared, or semiconductor system, apparatus, and device.

The present invention may be illustrated by the following, non-limiting examples.

### EXAMPLE 1

A potential buyer visits the sales lot of a Ford, Lincoln, Mercury® dealer in Marion, Ill., and sees a 2009 Lincoln MKX he likes. The potential buyer wants more information about that car and sees a sign displayed in the car's window: To hear automated information about the features of this vehicle, call 800.555.1111, ext. 205. And for more information, visit: vvvvw.cellthisdealer.com/8005551111/205 or www.cellthisdealer.com/marionford/205.

When the potential buyer calls the toll-free number and enters the extension, he hears an automated announcement describing that 2009 Lincoln MKX. The announcement also advises him to visit www.cellthisdealer.com/8005551111/205 or www.cellthisdealer.com/marionford/205 for more information.

When the potential buyer ends the call, he gets an automatic text message containing the web address of the web site where that Lincoln vehicle is displayed. The message also offers a special such as a free car wash and/or a coupon for a discounted oil change.

Entering that web address in a browser, or clicking the link displayed on a cell phone equipped with web browser capabilities, takes the prospective buyer directly to the web page where the vehicle is displayed, along with text, audio, graphics, slides, flash information about that vehicle, associated dealer (User) contact information , a map to the User's location, a link by which to send an email to User, and a link to that User-Dealer's main web site. Banner advertisements may be displayed that offer financing by banks and other financial institutions, as well as insurer and other advertisements.

### EXAMPLE 2

A potential buyer calls a User who has an ice cream shop and who has been assigned the toll-free number 866.555.0132 and extension 101. The potential buyer calls the number and hears a recorded announcement advising him to dial extension 101 to hear information he is interested in. The potential buyer may obtain additional information (text, pictures, Flash, contact info, a GOGGLE® map) by visiting: www.cellthisstore/8665550132/101.

### EXAMPLE 3

A potential buyer calls a Ford® dealer who has been assigned a toll-free number (866.555.5556) with multiple extensions. Upon calling the toll-free number, a recorded announcement advises the potential buyer to enter the extension of the vehicle he is interested in. The potential buyer enters that Extension (101), and hears an announcement describing the features of that vehicle. The potential buyer may then obtain additional information (text, audio, pictures, Flash, contact info, a Google map®) by visiting: www.cellthisdealer/8665555556/101.

### INDUSTRIAL APPLICABILITY

Methods for marketing the sale of goods and/or services and for disseminating information about such goods and services to prospective buyers are provided. The marketing of goods and/or services is effective to provide information. via a mobile phone, personal digital assistant, smart phone, and the world wide web.

Although specific embodiments of the invention have been described herein, it is understood by those skilled in the art that many other modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

1. A marketing method for goods and/or services, comprising:
assigning at least one telephone number and a web page to at least one user, said at least one user offering goods and/or services for sale to at least one prospective buyer;
contacting the at least one telephone number; and
sending a message to the at least one prospective buyer's mobile phone, personal digital assistant, or smart phone, said message providing a web address for said web page for obtaining information about the goods and/or services.

2. A marketing method according to claim 1, comprising calling the at least one telephone number and at least one extension and hearing an announcement providing information for the goods and/or services.

3. A marketing method according to claim 1, comprising assigning a telephone number with a plurality of extensions to the at least one user, each extension having a unique corresponding web page.

4. A marketing method according to claim 3, wherein each extension and corresponding unique web page provides information for a single good and/or service.

5. A marketing method according to claim 1, further comprising charging the at least one user a fee for at least one of the at least one telephone number or web page.

6. A marketing method according to claim 1, further comprising sending at least one coupon to the prospective buyer via text message or e-mail.

7. A marketing method according to claim 1, wherein sending a message to the prospective buyer comprises sending at least one of an e-mail, text message, or multimedia message to the prospective buyer's mobile phone, personal digital assistant, or smart phone.

8. A marketing method according to claim 7, wherein the message comprises at least one of pictures, sound, video, or location data.

9. A marketing method according to claim 1, further comprising:
recording at least one of the prospective buyer's telephone number or name; and
sending a forwarding message comprising at least one of the prospective buyer's telephone number or name to the at least one user.

10. A marketing method according to claim 1, wherein the at least one user uploads a file to the web page that is used to populate a greeting of the at least one telephone number.

11. A marketing method according to claim 1, wherein the at least one user sets up at least one coupon using a template and uploads the at least one coupon to the web page.

12. A marketing method according to claim 1, further comprising uploading at least one coupon to a social-networking website.

13. A marketing method according to claim 1, wherein a main web page is assigned to a plurality of users, each user having a separate unique landing web page linking to the main web page.

14. A marketing method according to claim 1, further comprising downloading an activity report for the at least one telephone number.

15. A marketing method according to claim 1, comprising providing an administrative web page to change, edit, or assign at least one of telephone numbers, extensions, advertisements, or coupons on the at least one user's web page.

16. A marketing method for goods and/or services, comprising:
assigning at least one telephone number and at least one extension and a web page to at least one user, said at least one user offering goods and/or services at a plurality of geographic locations for sale to at least one prospective buyer;
contacting the at least one telephone number and at least one extension; and
sending a message to the at least one prospective buyer's mobile phone, personal digital assistant, or smart phone, said message providing a web address for said web page for obtaining information about the goods and/or services.

17. A marketing method according to claim 16, wherein the at least one user has a telephone number with a plurality of extensions, each extension corresponding to a different geographic location.

18. A marketing method according to claim 17, wherein each geographic location comprises a sub-user.

19. A marketing method according to claim 18, wherein a sub-user comprises a franchise, subsidiary, or sub-corporation of the at least one user.

20. A marketing method according to claim 16, wherein the at least one user administers each sub-user's web page to standardize web pages of each sub-user.

21. A computer program product for marketing goods and/or services, comprising a computer readable storage medium having computer readable code that when executed causes the computer to:
assign at least one telephone number and web page to at least one user for offering goods and/or services for sale to a prospective buyer;
contact the at least one telephone number; and
send a message to the prospective buyer's mobile phone, personal digital assistant, or smart phone, said message providing a web address for said web page for obtaining information about the goods and/or services.
